(19) United States
(12) Patent Application Publication
(10) Pub. No.: US 2010/0157355 A1
(43) Pub. Date: Jun. 24, 2010

(54) Method For Printing A Handout For An Attendee Of A Meeting

(76) Inventor: Timothy Scott Seevers, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/342,171

(22) Filed: Dec. 23, 2008

(51) Int. Cl. G06F 3/12

(52) U.S. Cl. 358/1.15

(57) ABSTRACT

One exemplary method of the present invention is for printing a handout on a printer for an attendee of a meeting of a type having a scheduled starting date and time stored in a storage device and having a meeting location, wherein the handout is stored in the storage device in association with at least the scheduled starting date and time and wherein the printer is adapted for communication with the storage device and is installable at the meeting location. The method includes in response to a printer command, activating the printer to communicate with the storage device to identify the meeting based at least on the stored scheduled starting date and time and on a current date and time. The method also includes in response to a printer command made at the printer, activating the printer to pull print the stored handout associated with the identified meeting.

### TECHNICAL FIELD

The present invention relates generally to printers, and more particularly to a method for printing a handout on a printer for an attendee of a meeting.

### BACKGROUND OF THE INVENTION

Printers are used to print handouts such as a meeting agenda and copies of each speaker's notes and slides. A meeting organizer may create and store the agenda on his or her computer and electronically receive (such as over a network) and store the notes and slides from each speaker. The meeting organizer may then estimate the number of attendees expected to be at a meeting (such as a conference) knowing very well that the number of actual attendees may be greater or less than the number of invited attendees. The meeting organizer then commands the computer to print the estimated number of handouts on a connected printer and arranges to have the printed handouts taken to the conference room. Often, the meeting organizer has printed too few handouts and must make arrangements to send copies to those attendees who were not able to obtain them at the meeting, or the meeting organizer has printed too many handouts and must discard at least some of the extra copies.

What is needed is an improved method for printing a handout on a printer for an attendee of a meeting.

### SUMMARY OF THE INVENTION

A first method of the present invention is for printing a handout on a printer for an attendee of a meeting of a type having a scheduled starting date and time stored in a storage device and having a meeting location, wherein the handout is stored in the storage device in association with at least the scheduled starting date and time and wherein the printer is adapted for communication with the storage device and is installable at the meeting location. The first method includes in response to a printer command, activating the printer to communicate with the storage device to identify the meeting based at least on the stored scheduled starting date and time and a current date and time. The first method also includes in response to a printer command made at the printer, activating the printer to pull print the stored handout associated with the identified meeting.

A second method of the present invention is for printing a handout on a printer for an attendee of a meeting of a type having a scheduled starting date and time stored in a storage device and having a meeting location stored in the storage device, wherein the handout is stored in the storage device in association with at least the scheduled starting date and time and the meeting location and wherein the printer is adapted for communication with the storage device. The second method includes in response to a printer command, activating the printer to request entry of a printer location of the printer. The second method also includes in response to a printer command, activating the printer to communicate with the storage device to identify the meeting based at least on the stored scheduled starting date and time, the stored meeting location, the current date and time, and the printer location. The second method also includes in response to a printer command made at the printer, activating the printer to pull print the stored handout associated with the identified meeting.

A third method of the present invention is for printing a handout on a printer for an attendee of a meeting of a type having a scheduled starting date and time, a meeting duration, and a meeting location all stored in a storage device, wherein the handout is stored in the storage device in association with at least the scheduled starting date and time, the meeting duration, and the meeting location and wherein the printer is adapted for communication with the storage device over a network. The third method includes in response to a printer command, activating the printer to request entry of a printer location of the printer. The third method also includes in response to a printer command, activating the printer to communicate with the storage device over the network to identify the meeting based at least on the stored scheduled starting date and time, the stored meeting duration, the stored meeting location, the current date and time, and the printer location. The third method also includes in response to a printer command made at the printer, activating the printer to pull print the stored handout associated with the identified meeting.

### BRIEF DESCRIPTION OF THE DRAWINGS

FIG. 1 is a block diagram of a first method of the invention; and

FIG. 2 is a block diagram of a second method of the invention.

### DETAILED DESCRIPTION

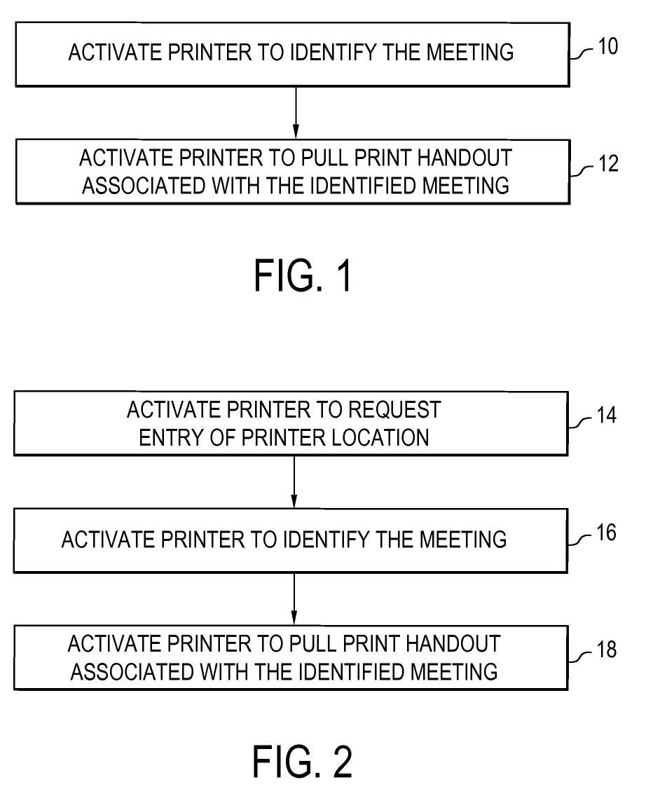

A first exemplary method of the present invention is for printing a 5 handout on a printer for an attendee of a meeting of a type having a scheduled starting date and time stored in a storage device and having a meeting location, wherein the handout is stored in the storage device in association with at least the scheduled starting date and time and wherein the printer is adapted for communication with the storage device and is installable at the meeting location. The first method includes in response to a printer command, activating the printer to communicate with the storage device to identify the meeting based at least on the stored scheduled starting date and time and a current date and time, as summarized in block 10 of FIG. 1. The first method also includes in response to a printer command made at the printer, activating the printer to pull print the stored handout associated with the identified meeting, as summarized in block 12 of FIG. 1.

In one example of the first exemplary method, the printer has a print button and displays “Push Print Button to Print Meeting Handout” on a printer display screen, wherein the attendee (or a printer operator) pushes the print button which initiates a printer command to activate the printer to pull print the stored handout associated with the identified meeting. In a different example, the printer has a touch screen which displays a print icon and the message “Touch Print Icon To Print Meeting Handout”, wherein the attendee (or a printer operator) touches the print icon on the touch screen which initiates a printer command to activate the printer to pull print the stored handout associated with the identified meeting. In the same or a different example, a printer operator commands the printer to enter a conference room printer mode which then initiates the printer command to activate the printer to communicate with the storage device to identify the meeting. In one variation, the printer is always kept on and in communication with the storage device.

In one utilization of the first exemplary method, the printer is installed at the meeting location by being installed in the meeting conference room. In a different utilization, the printer is installed at the meeting location by being installed outside and proximate the meeting conference room.

In one employment of the first exemplary method, an attendee authorization is stored in the storage device. In one variation, the first method also includes activating the printer to request an attendee authorization from the attendee, to communicate with the storage device to determine if the attendee authorization received by the printer from the attendee matches the stored attendee authorization, and to pull print the stored handout associated with the identified meeting only if the attendee is an authorized attendee. In one example, the attendee authorization is at least one of a group consisting of data stored on a swipe card of the attendee, a personal identification number of the attendee, and a password for the identified meeting.

In one enablement, the first exemplary method also includes activating the printer to offer the attendee an option to have the printer apply a finishing option when pull printing the stored handout. In one example, the finishing option is at least one of a group consisting of N-up, color versus mono, stapling, and duplex. It is noted that 1-up denotes printing one page of the document on one side of a piece of paper (or other print medium), 2-up denotes printing two pages of the document on one side of a piece of paper (or other print medium), and N-up denotes printing N pages of the document on one side of a piece of paper (or other print medium).

In one application of the first exemplary method, the meeting location (such as a conference room) is the only meeting location of an organization, wherein the organization is the only organization which uses the storage device to schedule meetings. In another application, the organization has more than one meeting location, the meeting location is also stored in the storage device, and the printer identifies the meeting based also on the stored meeting location. In one variation, a meeting duration is also stored in the storage device, and the printer identifies the meeting based also on the stored meeting duration.

In one modification, the meeting locations are scheduled by collaboration software having calendar, meeting, and conference room scheduling capability. Examples of collaboration software include Lotus Domino Server/Notes and Microsoft Exchange. In one arrangement, program code within the printer communicates over the network directly with the collaboration software. In a different arrangement, program code within the printer communicates directly with middleware which communicates directly with the collaboration software. In one variation, the storage device is connected to, or is a part of, a computer which acts as a server, wherein desktop computers and laptop computers of the meeting organizer and the meeting speakers are networked, or are capable of being networked, to the server.

A second exemplary method of the present invention is for printing a handout on a printer for an attendee of a meeting of a type having a scheduled starting date and time stored in a storage device and having a meeting location stored in the storage device, wherein the handout is stored in the storage device in association with at least the scheduled starting date and time and the meeting location and wherein the printer is adapted for communication with the storage device. The second method includes in response to a printer command, activating the printer to request entry of a printer location of the printer, as summarized in block 14 of FIG. 2. The second method also includes in response to a printer command, activating the printer to communicate with the storage device to identify the meeting based at least on the stored scheduled starting date and time, the stored meeting location, the current date and time, and the printer location, as summarized in block 16 of FIG. 2. The second method also includes in response to a printer command made at the printer, activating the printer to pull print the stored handout associated with the identified meeting, as summarized in block 18 of FIG. 2.

It is noted that the utilizations, examples, employments and enablements of the first exemplary method of the present invention are equally applicable to the second exemplary method of the present invention. In one variation, a printer operator commands the printer to enter a conference room printer mode which then initiates the printer command to activate the printer to request entry of a printer location of the printer.

A third exemplary method of the present invention is for printing a handout on a printer for an attendee of a meeting of a type having a scheduled starting date and time, a meeting duration, and a meeting location all stored in a storage device, wherein the handout is stored in the storage device in association with at least the scheduled starting date and time, the meeting duration, and the meeting location and wherein the printer is adapted for communication with the storage device over a network. The third method includes in response to a printer command, activating the printer to request entry of a printer location of the printer. The third method also includes in response to a printer command, activating the printer to communicate with the storage device over the network to identify the meeting based at least on the stored scheduled starting date and time, the stored meeting duration, the stored meeting location, the current date and time, and the printer location. The third method also includes in response to a printer command made at the printer, activating the printer to pull print the stored handout associated with the identified meeting.

In one extension, the meeting has a meeting name stored in the storage device, and the third exemplary method also includes activating the printer to request that the attendee confirm the meeting name if the current time is before the stored scheduled starting date and time. In the same or a different extension, the meeting has a meeting name stored in the storage device, and the third method also includes activating the printer to request that the attendee confirm the meeting name if the current time is after the stored meeting duration.

In one illustration of the third exemplary method, the handout is one of a plurality of stored handouts associated with the identified meeting, and the printer command which activates the printer to pull print the stored handout activates the printer to pull print the plurality of stored handouts associated with the identified meeting. In a different illustration, the handout is one of a plurality of stored handouts associated with the identified meeting, and the third method also includes activating the printer to display a list of the plurality of stored handouts associated with the identified meeting and to request that a selection be made of which of the stored handouts associated with the identified meeting the printer is to pull print. In one variation, the printer displays a menu screen offering the attendee a choice of “Print All Handouts” or “Print Selected Handouts”. If the attendee chooses “Print Selected Handouts”, the printer displays a menu screen requesting the attendee to select one or more handouts from a displayed list of all of the handouts of the identified meeting.

It is noted that the utilizations, examples, employments and enablements of the first exemplary method of the present invention are equally applicable to the third exemplary method of the present invention.

Several benefits and advantages are derived from at least one of the exemplary methods of the present invention. In one example, each actual attendee wanting handouts, or a particular handout, is provided a printed copy without too few or too many handouts being printed.

The foregoing description of several exemplary methods of the present invention has been presented for purposes of illustration. It is not intended to be exhaustive or to limit the invention to the precise actions and/or forms disclosed, and obviously many modifications and variations are possible in light of the above teaching. It is intended that the scope of the invention be defined by the claims appended hereto.

What is claimed is:

1. A method for printing a handout on a printer for an attendee of a meeting of a type: having a scheduled starting date and time stored in a storage device and having a meeting location, wherein the handout is stored in the storage device in association with at least the scheduled starting date and time, wherein the printer is adapted for communication with the storage device and is installable at the meeting location, and wherein the method comprises
a) in response to a printer command, activating the printer to communicate with the storage device to identify the meeting based at least on the stored scheduled starting date and time and a current date and time; and
b) in response to a printer command made at the printer, activating the printer to pull print the stored handout associated with the identified meeting.

2. The method of claim 1, wherein an attendee authorization is stored in the storage device, and also including activating the printer to request an attendee authorization from the attendee, to communicate with the storage device to determine if the attendee authorization received by the printer from the attendee matches the stored attendee authorization and to pull print the stored handout associated with the identified meeting only if the attendee is an authorized attendee.

3. The method of claim 2, wherein the attendee authorization is at least one of a group consisting of data stored on a swipe card of the attendee, a personal identification number of the attendee, and a password for the identified meeting.

4. The method of claim 1, also including activating the printer to offer the attendee an option to have the printer apply a finishing option when pull printing the stored handout.

5. The method of claim 4, wherein the finishing option is at least one of a group consisting of N-up, color versus mono, stapling, and duplex.

6. A method for printing a handout on a printer for an attendee of a meeting of a type having a scheduled starting date and time stored in a storage device and having a meeting location stored in the storage device, wherein the handout is stored in the storage device in association with at least the scheduled starting date and time and the meeting location, wherein the printer is adapted for communication with the storage device, and wherein the method comprises:
a) in response to a printer command, activating the printer to request entry of a printer location of the printer;
b) in response to a printer command, activating the printer to communicate with the storage device to identify the meeting based at least on the stored scheduled starting date and time, the stored meeting location, the current date and time, and the printer location; and
c) in response to a printer command made at the printer, activating the printer to pull print the stored handout associated with the identified meeting.

7. The method of claim 6, wherein an attendee authorization is stored in the storage device, and also including activating the printer to request an attendee authorization from the attendee, to communicate with the storage device to determine if the attendee authorization received by the printer from the attendee matches the stored attendee authorization and to pull print the stored handout associated with the identified meeting only if the attendee is an authorized attendee.

8. The method of claim 7, wherein the attendee authorization is at least one of a group consisting of data stored on a swipe card of the attendee, a personal identification number of the attendee, and a password for the identified meeting.

9. The method of claim 6, also including activating the printer to offer the attendee an option to have the printer apply a finishing option when pull printing the stored handout.

10. The method of claim 9, wherein the finishing option is at least one of a group consisting of N-up, color versus mono, stapling, and duplex.

11. A method for printing a handout on a printer for an attendee of a meeting of a type having a scheduled starting date and time, a meeting duration, and a meeting location all stored in a storage device, wherein the handout is stored in the storage device in association with at least the scheduled starting date and time, the meeting duration, and the meeting location, wherein the printer is adapted for communication with the storage device over a network, and wherein the method comprises:
a) in response to a printer command, activating the printer to request entry of a printer location of the printer;
b) in response to a printer command, activating the printer to communicate with the storage device over the network to identify the meeting based at least on the stored scheduled starting date and time, the stored meeting duration, the stored meeting location, the current date and time, and the printer location; and
c) in response to a printer command made at the printer, activating the printer to pull print the stored handout associated with the identified meeting.

12. The method of claim 11, wherein an attendee authorization is stored in the storage device, and also including activating the printer to request an attendee authorization from the attendee, to communicate with the storage device to determine if the attendee authorization received by the printer from the attendee matches the stored attendee authorization and to pull print the stored handout associated with the identified meeting only if the attendee is an authorized attendee.

13. The method of claim 12, wherein the attendee authorization is at least one of a group consisting of data stored on a swipe card of the attendee, a personal identification number of the attendee, and a password for the identified meeting.

14. The method of claim 11, also including activating the printer to offer the attendee an option to have the printer apply a finishing option when pull printing the stored handout.

15. The method of claim 14, wherein the finishing option is at least one of a group consisting of N-up, color versus mono, stapling, and duplex.

16. The method of claim 11, wherein the meeting has a meeting name stored in the storage device, and also including activating the printer to request that the attendee confirm the meeting name if the current time is before the scheduled starting date and time.

17. The method of claim 16, wherein the meeting has a meeting name stored in the storage device, and also including activating the printer to request that the attendee confirm the meeting name if the current time is after the meeting duration.

18. The method of claim 11, wherein the meeting has a meeting name stored in the storage device, and also including activating the printer to request that the attendee confirm the meeting name if the current time is after the meeting duration.

19. The method of claim 11, wherein the handout is one of a plurality of stored handouts associated with the identified meeting, and wherein the printer command which activates the printer to pull print the stored handout activates the printer to pull print the plurality of stored handouts associated with the identified meeting.

20. The method of claim 11, wherein the handout is one of a plurality of stored handouts associated with the identified meeting, and also including activating the printer to display a list of the plurality of stored handouts associated with the identified meeting and to request that a selection be made of which of the stored handouts associated with the identified meeting the printer is to pull print.
